(19) United States
(12) Patent Application Publication
(10) Pub. No.: US 2026/0248066 A1
(43) Pub. Date: Aug. 27, 2026

(54) AUTONOMOUS ACTIVATION OF OUTDOOR POWER EQUIPMENT

(71) Applicant: HUSQVARNA AB, Huskvarna (SE)

(72) Inventors: Ryan PAGE, Denver, NC (US); Sean DWYER, Gastonia, NC (US)

(21) Appl. No.: 19/163,336

(22) PCT Filed: Mar. 8, 2024
(86) PCT No.: PCT/US2024/019018

§ 371 Date: Sep. 8, 2025

Related U.S. Application Data
(60) Provisional application No. 63/451,016, filed on Mar. 9, 2023.

(51) Int. Cl. A01D 34/00; A01B 69/04; A01D 34/64; A01D 34/74; A01D 101/00; B60Q 9/00; G05D 1/224; G05D 1/617; G05D 105/15

(52) U.S. Cl. CPC A01D 34/008; A01B 69/008; A01D 34/64; A01D 34/74; B60Q 9/00; G05D 1/2247; G05D 1/617; A01D 2101/00; G05D 2105/15

(57) ABSTRACT

An autonomous control module for a riding lawn care vehicle may include a vehicle interface and a shutdown controller. The vehicle interface may define a physical and electrical connection to the riding lawn care vehicle to enable the autonomous control module to alternately be installed at or removed from the riding lawn care vehicle to transition a mode controller of the riding lawn care vehicle between a manual operation mode when the autonomous control module is installed at the riding lawn care vehicle and an autonomous operation mode when the autonomous control module is removed from the riding lawn care vehicle. The shutdown controller may be configured to enable a remote shutdown of the riding lawn care vehicle when actuated by an operator while the riding lawn care vehicle is in the autonomous operation mode.

### TECHNICAL FIELD

Example embodiments generally relate to outdoor power equipment and, more particularly, some embodiments relate to a module that can be used to control autonomous activation of outdoor power equipment that can be operated either in an autonomous mode or a manual control mode.

### BACKGROUND

Lawn care tasks are commonly performed using various tools and/or machines that are configured for the performance of corresponding specific tasks. Certain tasks, like grass cutting, are typically performed by lawn mowers. Lawn mowers themselves may have many different configurations to support the needs and budgets of consumers. Walk-behind lawn mowers are typically compact, have comparatively small engines and are relatively inexpensive. Meanwhile, at the other end of the spectrum, riding lawn mowers, such as lawn tractors, can be quite large. Riding lawn mowers can sometimes also be configured with various functional accessories (e.g., trailers, tillers and/or the like) in addition to grass cutting components. Riding lawn mowers provide the convenience of a riding vehicle as well as a typically larger cutting deck as compared to a walk-behind model.

Meanwhile, robotic mowers have more recently become quite popular, and such robotic mowers operate autonomously to perform lawn care tasks after initial setup. Up until now, manually operated vehicles (whether walked behind or ridden upon) and robotic mowers have generally been completely different and distinct in both design and operation. However, it may be possible to design such a vehicle to operate in either mode (e.g., autonomous of manual operation modes). If such a multi-modal vehicle is designed, it may be desirable to further control the switching between modes in a convenient and functionally advantageous way.

### BRIEF SUMMARY OF SOME EXAMPLES

Some example embodiments may provide a riding lawn care vehicle that may include an engine to selectively power the riding lawn care vehicle, a power supply to provide electrical power to the riding lawn care vehicle, and an autonomous control module. The autonomous control module may include a vehicle interface and a shutdown controller. The vehicle interface may define a physical and electrical connection to the riding lawn care vehicle to enable the autonomous control module to alternately be installed at or removed from the riding lawn care vehicle to transition a mode controller of the riding lawn care vehicle between a manual operation mode when the autonomous control module is installed at the riding lawn care vehicle and an autonomous operation mode when the autonomous control module is removed from the riding lawn care vehicle. The shutdown controller may be configured to enable a remote shutdown of the engine of the riding lawn care vehicle when actuated by an operator while the riding lawn care vehicle is in the autonomous operation mode.

In another example embodiment, an autonomous control module for a riding lawn care device may be provided. The autonomous control module may include a vehicle interface and a shutdown controller. The vehicle interface may define a physical and electrical connection to the riding lawn care vehicle to enable the autonomous control module to alternately be installed at or removed from the riding lawn care vehicle to transition a mode controller of the riding lawn care vehicle between a manual operation mode when the autonomous control module is installed at the riding lawn care vehicle and an autonomous operation mode when the autonomous control module is removed from the riding lawn care vehicle. The shutdown controller may be configured to enable a remote shutdown of the riding lawn care vehicle when actuated by an operator while the riding lawn care vehicle is in the autonomous operation mode.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIG. 1 illustrates a perspective view of the riding lawn care vehicle according to an example embodiment;

FIG. 2 illustrates a functional block diagram of an autonomous control module of an example embodiment;

FIG. 3 illustrates a functional block diagram of a control system including the autonomous control module according to an example embodiment; and

FIG. 4 illustrates a functional block diagram of the autonomous control module of FIG. 2 with various additional components according to an example embodiment.

### DETAILED DESCRIPTION

Some example embodiments now will be described more fully hereinafter with reference to the accompanying drawings, in which some, but not all example embodiments are shown. Indeed, the examples described and pictured herein should not be construed as being limiting as to the scope, applicability or configuration of the present disclosure. Rather, these example embodiments are provided so that this disclosure will satisfy applicable legal requirements. Like reference numerals refer to like elements throughout. Furthermore, as used herein, the term “or” is to be interpreted as a logical operator that results in true whenever one or more of its operands are true. Additionally, the term “lawn care” is meant to relate to any yard maintenance activity and need not specifically apply to activities directly tied to grass, turf or sod care. As used herein, operable coupling should be understood to relate to direct or indirect connection that, in either case, enables functional interconnection of components that are operably coupled to each other.

To the extent a particular lawn care vehicle can be operated in either a manual control mode (where the operator is in contact with and physically controls the operation of the lawn care vehicle) or an autonomous mode (where the operator is either remote from the vehicle or at least not in contact with the vehicle as the vehicle operates under its own autonomous control), it may be desirable to define a convenient way to initiate the transfer between modes, while also ensuring positive control of the vehicle is always maintained. To accomplish this, some example embodiments may provide for autonomous activation (i.e., switching to the autonomous mode) to be initiated responsive to removal of a physical device or component from the vehicle to be retained by the operator while in the autonomous mode. This physical device or component may take multiple forms, as will be discussed below, and will be generally referred to (in all such forms) as an autonomous activation module.

In an example embodiment, the autonomous activation module may include remote controls, or at least the ability to shutdown (or “kill”) operation of the vehicle in the autonomous mode. Thus, for example, the autonomous activation module could take the form of a handheld, remote safety or kill switch in a basic form, or a full or partial human machine interface (HMI) with various levels of interaction being supported. When the autonomous activation module is attached to the vehicle, the vehicle may be operated locally by a human operator only via the manual controls of the vehicle itself. However, when the autonomous activation module is removed from the vehicle (e.g., and held by the operator at some remote location), the vehicle may transfer to the autonomous mode and begin autonomous operations accordingly.

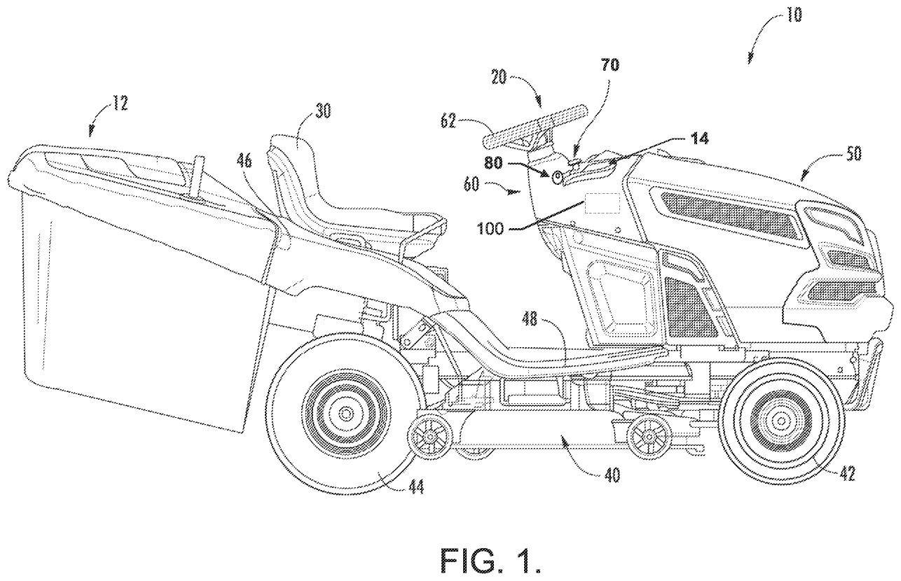

FIG. 1 illustrates an example lawn care device in the form of a riding lawn care vehicle 10 having a bagging attachment 12. However, it should be appreciated that example embodiments may be employed on numerous other riding lawn care vehicles that may not include a bagging attachment 12. The riding lawn care vehicle 10 may include an operations panel 14 that may display operational information regarding the riding lawn care vehicle 10 and host various controls, gauges, switches, lights, displays, and/or the like. As shown and described herein, the riding lawn care vehicle 10 may be a riding lawn mower (e.g., a lawn tractor, front-mount riding lawn mower, riding lawn mower with a zero or near zero degree radius of turn, cross mower, stand-on riding lawn mower, and/or the like). However, example embodiments may also or alternatively be employed on other outdoor power equipment devices, such as walk behind lawn mowers, tillers, snow throwers, and/or the like, or even on hand-held devices that employ relatively small gasoline or petrol engines so long as such devices have the ability to propel and navigate themselves in an autonomous mode of operation.

The riding lawn care vehicle 10 may include a steering assembly 20 (e.g., including a steering wheel, handle bars, or other steering apparatus) functionally connected to wheels of the riding lawn care vehicle 10 to which steering inputs are provided (e.g., the front and/or rear wheels in various different embodiments) to allow the operator to steer the riding lawn care vehicle 10. In some embodiments, the riding lawn care vehicle 10 may include a seat 30 that may be disposed at a center, rear, or front portion of the riding lawn care vehicle 10. The operator may sit on the seat 30, which may be disposed to the rear of the steering assembly 20 to provide input for steering of the riding lawn care vehicle 10 via the steering assembly 20.

The riding lawn care vehicle 10 may also include, or be configured to support attachment of, a cutting deck 40 having at least one cutting blade mounted therein. In some cases, a height of the at least one cutting blade may be adjustable by an operator of the riding lawn care vehicle 10. The cutting deck 40 may be a fixed or removable attachment in various different embodiments. Moreover, a location of the cutting deck 40 may vary in various alternative embodiments. For example, in some cases, the cutting deck 40 may be positioned in front of the front wheels 42, behind the rear wheels 44, or in between the front and rear wheels 42 and 44 (as shown in FIG. 1) to enable the operator to cut grass using the at least one cutting blade when the at least one cutting blade is rotated below the cutting deck 40. In some embodiments, the cutting deck 40 may be lifted or rotated relative to the lawn mower frame to permit easier access to the underside of the lawn mower without requiring removal of the cutting deck 40. The cutting deck 40 may have one, two, three, or more cutting blades driven by one, two, three, or more rotatable shafts. The shafts may be rotated by any number of mechanisms. For example, in some embodiments, the shafts are coupled to a motor via a system of belts and pulleys. In other embodiments, the shafts may be coupled to the motor via a system of universal joints, gears, and/or other shafts. In still other embodiments, such as in an electric lawn mower, the shaft may extend directly from an electric motor positioned over the cutting deck.

In some embodiments, the front wheels 42 and/or the rear wheels 44 may have a shielding device positioned proximate thereto in order to prevent material picked up in the wheels from being ejected toward the operator. Fender 46 is an example of such a shielding device.

When operating to cut grass, the grass clippings may be captured by a collection system (e.g., bagging attachment 12), mulched, or expelled from the cutting deck 40 via either a side discharge or a rear discharge.

The riding lawn care vehicle 10 may also include additional control-related components such as one or more speed controllers, brakes, cutting height adjusters, and/or the like. Some of the controllers, such as the speed controllers and/or brakes, may be provided in the form of foot pedals that may sit proximate to a footrest 48 (which may include a portion on both sides of the riding lawn care vehicle 10) to enable the operator to rest his or her feet thereon while seated in the seat 30.

In the pictured example embodiment of FIG. 1, an engine 50 of the riding lawn care vehicle 10 is disposed substantially forward of a seated operator. However, in other example embodiments, the engine 50 could be in different positions such as below or behind the operator. In some embodiments, the engine 50 may be operably coupled to one or more of the wheels of the riding lawn care vehicle 10 in order to provide drive power for the riding lawn care vehicle 10. In some embodiments, the engine 50 may be capable of powering two wheels, while in others, the engine 50 may power all four wheels of the riding lawn care vehicle 10. Moreover, in some cases, the engine 50 may manually or automatically shift between powering either two wheels or all four wheels of the riding lawn care vehicle 10. The engine 50 may be housed within a cover that forms an engine compartment to protect engine 50 components and improve the aesthetic appeal of the riding lawn care vehicle 10.

In an example embodiment, the engine compartment may be positioned proximate to and/or mate with portions of a steering assembly housing 60. The steering assembly housing 60 may house components of the steering assembly 20 to protect such components and improve the aesthetic appeal of the riding lawn care vehicle 10. In some embodiments, a steering wheel 62 of the steering assembly 20 may extend from the steering assembly housing 60 and a steering column (not shown) may extend from the steering wheel 62 down through the steering assembly housing 60 to components that translate inputs at the steering wheel 62 to the wheels to which steering inputs are provided.

In some embodiments, the engine 50 may also provide power to turn the cutting blade or blades disposed within the cutting deck 40. In this regard, for example, the engine 50 may be used to turn a shaft upon which the cutting blade or blades may be fixed (e.g., via a belt and pulley system and/or other mechanisms). The turning of the shaft, at high speeds, may move the cutting blade or blades through a range of motion that creates air movement that tends to straighten grass for cutting by the moving blade and then eject the cut grass out of the cutting deck 40 (e.g., to the bagging attachment 12 or to the back or side of the riding lawn care vehicle 10), unless the blade and mower are configured for mulching.

In an example embodiment, the engine 50 may turn at least one shaft that is coupled to corresponding ones of one or more cutting blades within the cutting deck 40 via a PTO clutch. When the PTO clutch is engaged, rotary power generated by the engine 50 may be coupled to the one or more cutting blades to cause rotation thereof (e.g., for cutting grass).

When the PTO clutch is disengaged, rotary power generated by the engine 50 may not be coupled to the one or more cutting blades and thus the cutting blades may not rotate. In some embodiments, engagement of the PTO clutch may be accomplished via operation of a PTO switch 70 that may be disposed on or proximate to the operations panel 14. However, more simply constructed vehicles may turn the blades whenever the engine runs.

The operations panel 14, or some other portion of the steering assembly housing 60, may also provide support for an ignition interface 80. The ignition interface 80 may be used for starting the engine 50 and for controlling other functions of the riding lawn care vehicle 10.

In an example embodiment, the ignition interface 80 may or may not require a key to operate. Thus, the operator of the riding lawn care vehicle 10 may be enabled to start and/or initiate one or more functional capabilities of the riding lawn care vehicle 10 either with or without the use of a physical key using the ignition interface 80.

For a relatively robust and sophisticated device like the riding lawn care vehicle 10 of FIG. 1, or for more simply constructed versions, it may be possible to enable the riding lawn care vehicle 10 to have multiple modes of operation including, for example, a manual mode of operation and an autonomous mode of operation. In the manual mode of operation, the operator may sit at the seat 30 and operate the riding lawn care vehicle 10 via the steering assembly 20 and PTO switch 70, among other controls. Meanwhile, in the autonomous mode of operation, the riding lawn care vehicle 10 may operate without any operator in the seat 30, and without manual and local control of the steering assembly 20 or other controls. In some cases, the guidance of the riding lawn care vehicle 10 may be random within a bounded area while in the autonomous mode. However, in other examples, the riding lawn care vehicle 10 may follow a programmed or learned route in the autonomous mode.

In generic terms, it may be thought possible to allow the operator to actuate a switch or other operable member to change the mode of operation between the autonomous and manual modes. However, such a simplified approach has numerous problems including how to stop the vehicle when in the autonomous mode, and various issues with transition between modes. To overcome these problems, an autonomous control module 100 may be employed to facilitate both transitioning between modes, and stopping the riding lawn care vehicle 10 when in the autonomous mode.

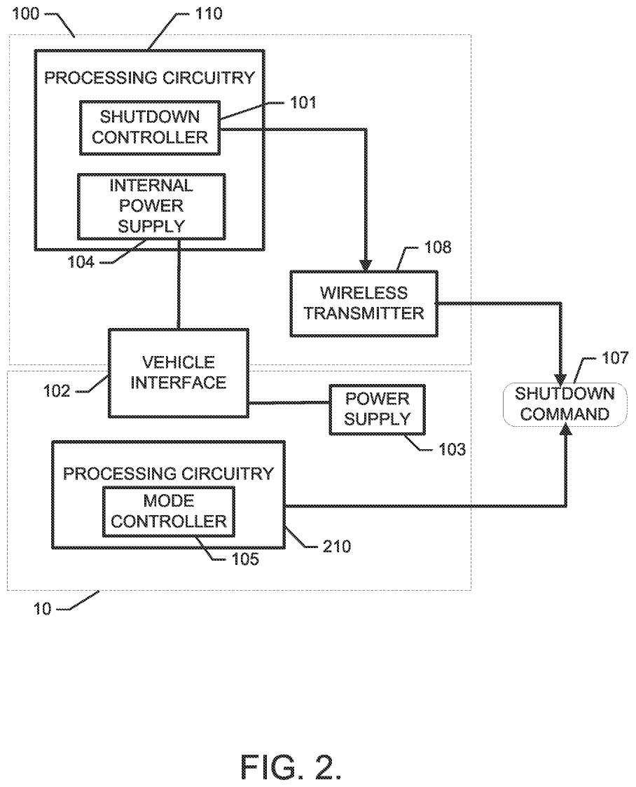

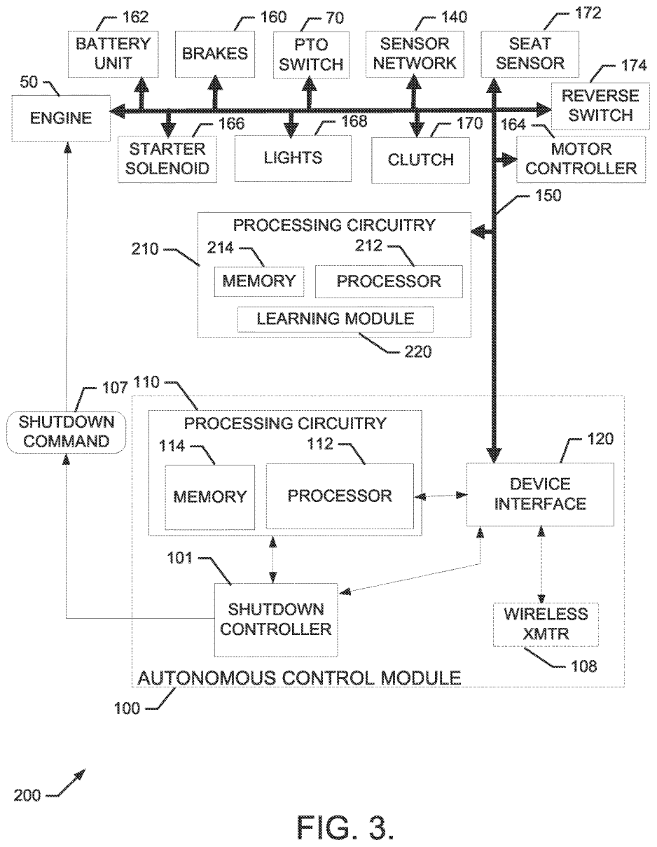

With respect to this latter function, the autonomous control module 100 may have the ability (among perhaps many other abilities) to act as a kill switch to shutdown the machine remotely. A specific example implementation for the autonomous control module 100 for doing so will be discussed by way of non-limiting example in greater detail below in reference to FIG. 3. However, as noted above, it may be possible to employ this functionality on smaller and less sophisticated units as well. Example embodiments may provide the autonomous control module 100 such that it can be added to vehicles of almost any size to augment or add multimodal operation capability to such vehicles. Thus, FIG. 2 is provided as a high level, and generic example of the autonomous control module 100 in accordance with an example embodiment. Before turning to FIGS. 2 and 3, however, it should be noted that the autonomous control module 100 of FIG. 1 is shown in dashed lines in a portion of the steering assembly housing 60, but could be located anywhere. The location could be internal or external, and may be moved to any suitable place within or on the riding lawn care vehicle 10.

FIG. 2 illustrates a functional block diagram of the autonomous control module 100 of an example embodiment. As shown in FIG. 2, the autonomous control module 100 may include a shutdown controller 101 and a vehicle interface 102 that is configured to provide the physical and/or electrical connections to the riding lawn care vehicle 10 when the autonomous control module 100 is installed in or otherwise attached to the riding lawn care vehicle 10. Thus, for example, in some cases, the vehicle interface 102 may include a physical structure or shape that is configured to fit with a corresponding structure or shape of a receiving portion of the riding lawn care vehicle 10. Moreover, in some cases, the vehicle interface 102 may be structured to fit between a power supply 103 of the riding lawn care vehicle 10 and a battery receptacle that otherwise receives the power supply 103 (e.g., battery). In such a case, the vehicle interface 102 may have charge receptacles that match those of the power supply 103 (e.g., battery unit 162 of FIG. 3), and may also have charge connections that match those of the riding lawn care vehicle 10. The power of the power supply 103 may therefore pass through the vehicle interface 102 to power the riding lawn care vehicle 10 when the autonomous control module 100 is installed in the riding lawn care vehicle 10. This arrangement may further enable the autonomous control module 100 itself to be charged (e.g., via internal power supply 104) when installed to provide power to the autonomous control module 100 when removed from the riding lawn care vehicle 10. In such cases, when the autonomous control module 100 is removed, the power supply 103 may directly interface with the power receptacle of the riding lawn care vehicle 10.

The autonomous control module 100 may also include processing circuitry 110, which will be described in greater detail below. However, it should generally be understood that the processing circuitry 110 can either include a microprocessor specifically for the autonomous control module 100, which is capable of being programmed to execute functions associated with supporting operation of the autonomous control module 100 as described herein.

When the autonomous control module 100 is attached to the riding lawn care vehicle 10 by being physically installed thereat, all startup and shutdown operations of the riding lawn care vehicle 10 may operate normally (e.g., via key on, key off, or various other start/stop buttons or switches). However, when the autonomous control module 100 is detached (physically) from the riding lawn care vehicle 10, the removal of the autonomous control module 100 may initiate a mode change in a mode controller 105 of the riding lawn care vehicle 10. The mode controller 105 may therefore transition operation of the riding lawn care vehicle 10 from manual operation that is undertaken by an operator to autonomous operation (i.e., without input from any operator locally at the riding lawn care vehicle 10). The mode controller 105, (or an instance of processing circuitry 210 of the riding lawn care vehicle 10) may also initiate or participate in the performance of other functions described in greater detail below.

When the autonomous control module 100 is removed from the riding lawn care vehicle 10, as noted above, the riding lawn care vehicle 10 may initiate autonomous operation in an autonomous mode of operation. This autonomous operation may continue in accordance with programming executed by the processing circuitry 210 of the riding lawn care vehicle 10 unless a remote shutdown is initiated via the shutdown controller 101. In other words, for example, the shutting down of the engine 50 may be accomplished via the shutdown controller 101, which may be actuated remotely by an operator that is not otherwise seated at or physically in contact with any controls local to the riding lawn care vehicle 10. In some cases, the shutdown controller 101 may issue a shutdown command 107 to an engine control unit of the engine 50 for the performance of a shutdown function. However, in other cases, the shutdown controller 101 may utilize other methods of control to shut the engine 50 or more generally the riding lawn care vehicle 10 down.

In some embodiments, the shutdown command 107 may be wirelessly transmitted via a wireless transmitter 108 of the autonomous control module 100. The wireless transmission may be via any suitable wireless signaling means or protocol. Thus, for example, in some cases the wireless transmitter 108 may employ WiFi, Bluetooth, Zigbee, or various other known short range wireless communication protocols. However, a proprietary signaling means may alternatively be employed, if desired or practicable.

FIG. 3 illustrates a functional block diagram for explaining the operation of a vehicle or engine control system 200 incorporating the autonomous control module 100 of an example embodiment. As shown in FIG. 3, the autonomous control module 100 may include the processing circuitry 110 mentioned above to control operation of remote interaction with the riding lawn care vehicle 10 while in the autonomous mode of an example embodiment as described herein. In this regard, for example, the autonomous control module 100 may utilize the processing circuitry 110 to provide electronic control inputs to one or more functional units of the autonomous control module 100, as described herein. Meanwhile, the riding lawn care vehicle 10 may have its own instance of processing circuitry 210 to process data generated by the one or more functional units regarding various operational parameters relating to the riding lawn care vehicle 10. The processing circuitry 110 and/or 210 may be configured to perform data processing, control function execution, and/or other processing and management services according to an example embodiment of the present invention. In some embodiments, the processing circuitry 110/210 may be embodied as a chip or chip set. In other words, the processing circuitry 110/210 may comprise one or more physical packages (e.g., chips) including materials, components, and/or wires on a structural assembly (e.g., a baseboard). The structural assembly may provide physical strength, conservation of size, and/or limitation of electrical interaction for component circuitry included thereon. The processing circuitry 110/210 may therefore, in some cases, be configured to implement an embodiment of the present invention on a single chip or as a single “system on a chip.” As such, in some cases, a chip or chipset may constitute means for performing one or more operations for providing the functionalities described herein.

However, in some embodiments, the processing circuitry 110 of the autonomous control module 100 may be minimal in its structure and sophistication and may effectively only be capable of operating the shutdown controller 101 to perform the shutdown function by issuing the shutdown command 107 to the riding lawn care vehicle 10. In some cases, the shutdown command 107 may be provided to the engine 50 (directly or indirectly). However, in other cases, the shutdown command 107 may be provided to processing circuitry 210 of the riding lawn care vehicle 10 and the processing circuitry 210 of the riding lawn care vehicle 10 may issue any local or internal shutdown operations needed to shutdown the engine 50 and/or other operational components of the riding lawn care vehicle 10.

In an example embodiment, the processing circuitry 110 (if more complex than the simple version discussed above, and similarly the processing circuitry 210 of the riding lawn care vehicle 10, may include respective one or more instances of a processor and memory (e.g., processor 112 and memory 114 for the processing circuitry 110 of the autonomous control module 100, and processor 212 and memory 214 for the processing circuitry 210 of the riding lawn care vehicle 10) that may be in communication with or otherwise control a device interface 120 and, in some cases, a user interface. As such, the processing circuitry 110 or 210 may be embodied as a circuit chip (e.g., an integrated circuit chip) configured (e.g., with hardware, software, or a combination of hardware and software) to perform operations described herein. However, in some embodiments, the processing circuitry 110/210 may be embodied as a portion of an on-board computer of the autonomous control module 100 and riding lawn care vehicle 10, respectively. In some embodiments, the processing circuitry 110 of the autonomous control module 100 (when installed) and the processing circuitry 210 of the riding lawn care vehicle 10 (in all cases) may communicate with electronic components and/or sensors of a sensor network 140 (e.g., sensors that measure variable values related to riding lawn care vehicle parameters) of the riding lawn care vehicle 10 via a single data bus or multiple data buses (e.g., data bus 150), which may form a portion of the device interface 120 or which may connect to the device interface 120. As such, the data bus 150 may connect to a plurality or all of the sensors, switching components, and/or other electrically-controlled components of the riding lawn care vehicle 10 to the processing circuitry 110/210.

In an example embodiment, the data bus 150 may further provide a mechanism by which the processing circuitry 110/210 can interface with or control other functional units of the riding lawn care vehicle 10. For example, in some embodiments, the data bus 150 may provide control inputs to and/or receive status inputs from functional units such as any or all of the engine 50, PTO switch 70, brakes 160 (which may include a parking brake), a battery unit 162, one or more motor controllers 164, a starter solenoid 166, lights 168, clutch 170, seat sensor 172, reverse switch 174, and/or the like.

The user interface, if included, may be in communication with the processing circuitry 110/210 to receive an indication of a user input at the user interface and/or to provide an audible, visual, mechanical, or other output to the user. As such, the user interface may include, for example, a display, one or more levers, switches, buttons or keys (e.g., function buttons), and/or other input/output mechanisms. In an example embodiment, the user interface of the riding lawn care vehicle 10 may include the ignition interface 80, which may further include a plurality of light indicators, a plurality of function buttons, and/or a simple display. Meanwhile, for example, the user interface of the autonomous control module 100 may include a button or switch that can be actuated by the operator to actuate the shutdown controller 101 to issue the shutdown command 107. However, in some cases, the autonomous mode of operation may only be possible while the button or switch remains depressed or actuated (indicating positive control and monitoring by the remote operator), and the shutdown command 107 may be sent upon release of the button or switch.

The light indicators of the user interface may be LEDs or LED backlit images that are lit or unlit to indicate corresponding status information. The information indicated by the light indicators may be directly related to the corresponding function buttons in some cases.

However, in other cases, some of the light indicators may indicate status information associated with other functional units (e.g., those connected to the data bus 150). Meanwhile, the function buttons may be employed for initiation of various control operations to actuate or turn off corresponding ones of the functional units. However, in an example embodiment, the function buttons may also have an alternative functionality associated with starting of the engine 50. In still other cases, the user interface may be remotely located from the riding lawn care vehicle 10. Thus, for example, the user interface may be located at a terminal or cell phone that is remotely located and communicatively coupled to the riding lawn care vehicle 10 wirelessly.

The device interface 120 may include one or more interface mechanisms for enabling communication with other devices (e.g., sensors of the sensor network 140 and/or other accessories or functional units such as motors, engines, servos, switches, or other operational control devices for providing control functions). In some cases, the device interface 120 may be any means such as a device or circuitry embodied in either hardware, or a combination of hardware and software that is configured to receive and/or transmit data from/to sensors in communication with the processing circuitry 110/210, e.g., via the data bus 150. Thus, for example, the device interface 120 may provide interfaces for communication of components of the riding lawn care vehicle 10 via the data bus 150.

The processors 112 and 212 may be similar in functional capability, and sometimes also in form and specific function. The memories 114 and 214 may also be similar in functional capability, and sometimes also in form and specific function. Accordingly, only the processor 112 and memory 114 will be described below in greater detail since it should be understood that similar detailed descriptions may apply for the processor 212 and memory 214.

The processor 112 may be embodied in a number of different ways. For example, the processor 112 may be embodied as various processing means such as one or more of a microprocessor or other processing element, a coprocessor, a controller, or various other computing or processing devices including integrated circuits such as, for example, an ASIC (application specific integrated circuit), an FPGA (field programmable gate array), or the like. In an example embodiment, the processor 112 may be configured to execute instructions stored in the memory 114 or otherwise accessible to the processor 112. As such, whether configured by hardware or by a combination of hardware and software, the processor 112 may represent an entity (e.g., physically embodied in circuitry-in the form of processing circuitry 110) capable of performing operations according to embodiments of the present invention while configured accordingly. Thus, for example, when the processor 112 is embodied as an ASIC, FPGA, or the like, the processor 112 may be specifically configured hardware for conducting the operations described herein. Alternatively, as another example, when the processor 112 is embodied as an executor of software instructions, the instructions may specifically configure the processor 112 to perform the operations described herein.

The control system 200 may further include or be operably coupled to an instance of the autonomous control module 100 of an example embodiment. The autonomous control module 100 may be any means or device configured to perform the corresponding functionality of the autonomous control module 100 as described herein. In some cases, the autonomous control module 100 may include circuitry embodied in either hardware, or a combination of hardware and software that is configured to provide the shutdown command 107 responsive to input from an operator while the autonomous control module 100 is removed from the riding lawn care vehicle 10.

In an example embodiment, the processor 112 (or the processing circuitry 110) may be embodied as, include, or otherwise control the operation of the autonomous control module 100 (or riding lawn care vehicle 10 in the case of processor 212) based on inputs received by the processing circuitry 110 responsive to positioning of the function buttons and/or the operation of various ones of the functional units. As such, in some embodiments, the processor 112 (or riding lawn care vehicle 10 in the case of processor 212) may be said to cause each of the operations described in connection with the autonomous control module 100 (or riding lawn care vehicle 10) in relation to operation of the functional units and/or function buttons to undertake the corresponding functionalities responsive to execution of instructions or algorithms configuring the processor 112 (or processing circuitry 110) accordingly.

In an exemplary embodiment, the memory 114 may include one or more non-transitory memory devices such as, for example, volatile and/or non-volatile memory that may be either fixed or removable. The memory 114 may be configured to store information, data, applications, instructions, or the like for enabling the processing circuitry 110 to carry out various functions in accordance with exemplary embodiments of the present invention. For example, the memory 114 could be configured to buffer input data for processing by the processor 112. Additionally or alternatively, the memory 114 could be configured to store instructions for execution by the processor 112. As yet another alternative or additional capability, the memory 114 may include one or more databases that may store a variety of data sets responsive to input from the sensor network 140, functional units, and/or the function buttons. Among the contents of the memory 114, applications may be stored for execution by the processor 112 in order to carry out the functionality associated with each respective application. In some cases, the applications may include instructions for providing the mode controller 105 as described herein.

The mode controller 105 may be aware, e.g., via a switch, actuator, etc.) as to the presence or absence of the autonomous control module 100 at the riding lawn care vehicle 10. Thus, for example, when the autonomous control module 100 is present, the mode controller 105 may be aware of the presence, and may cause the processing circuitry 210 to operate the riding lawn care vehicle 10 in a manual operation mode where normal, local control of the riding lawn care vehicle 10 is employed via a seated operator at the seat 30 operating the riding lawn care vehicle 10 via the steering assembly 20 and PTO switch 70, among other controls. However, when the autonomous control module 100 is removed from the riding lawn care vehicle 10, the mode controller 105 may be aware of the absence, and may transition to the autonomous mode of operation, as described above. The vehicle interface 102 may, for example, when physically removed, cause a change that is detectable or directly initiated at the mode controller 105 to give the mode controller 105 notice of the change in status so that the mode controller 105 can transition to the autonomous mode of operation.

In an example embodiment, various ones of the functional units may impact each other. For example, the PTO switch 70 (which may be an electric or manual switch) may be used to alter a position of the clutch 170. Likewise, the motor controller 164 (if employed) may impact the application of battery power from the battery unit 162 to either a drive motor or a cutting motor. The position of the starter solenoid 166 may impact operation of the engine 50. Inputs regarding position of the brakes 160 and/or the PTO switch 70 may impact operation of the clutch 170, engine 50, and/or the like. Battery unit 162 status, status of the lights 168, and/or other sensor network component status may be reported to and/or controlled by operation of the function buttons 134. Accordingly, it should be appreciated that the control system 200 of an example embodiment, and particularly the data bus 150 and the processing circuitry 110 may enable the user interface to provide a relatively robust interface mechanism for controlling starter operation and numerous other functions of the riding lawn care vehicle 10.

In an example embodiment, the processing circuitry 210 may further include or embody a learning module 220. The learning module 220 may be configured to learn or otherwise become aware of one or more autonomous operation programs that may be pre-loaded, or actively learned. When in the autonomous mode of operation, the riding lawn care vehicle 10 may execute the program, which may include guided route execution (e.g., via GPS, visual markers, radio frequency signal or beacon based navigation, and/or the like) or random operation within a defined boundary. However, when active learning is employed, the learning module 220 may learn a route step by step via recording a prior performance of each step by an operator while the operator places the learning module 220 in a learning mode.

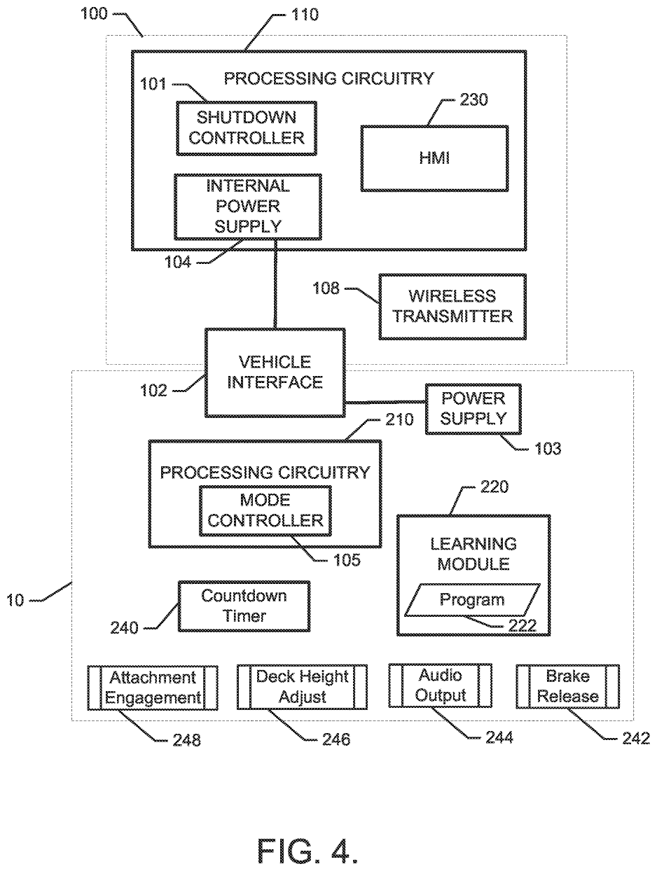

Various other additional capabilities or functions may also be implemented in connection with the learning module 220 in some cases. FIG. 4 illustrates a block diagram of an augmented or functionally upgraded version of the autonomous control module 100 of FIG. 2.

Referring now to FIG. 4, the autonomous control module 100 may further include a human machine interface (HMI) 230. The HMI may include a display, speaker, and in some cases also various input controls that can be used not only to actuate the shutdown controller 101, but in some cases to take remote control of the riding lawn care vehicle 10 (e.g., for programming a route into the learning module 220). In such cases, the autonomous control module 100 may effectively provide a handheld control module for the riding lawn care vehicle 10. The riding lawn care vehicle 10 may include a camera and its own wireless transmitter (or transceiver) to provide images to the HMI 230. In such cases, the camera may turn on automatically when the riding lawn care vehicle 10 operates in the autonomous mode of operation.

As noted above, the learning module 220 may store one or more instances of a program 222, which may define a random or pre-programmed route for operation of the riding lawn care vehicle 10 to service a parcel when in the autonomous mode of operation. In some cases, the operator may select one of the programs to be executed via the HMI 230. However, in others, only a single program 222 may be included and may be operated by default, or local controls at the riding lawn care vehicle 10 may be used to select a program.

The learning module 220 may be operably coupled to a countdown timer 240 in some cases, and the shift to the autonomous mode of operation may be delayed based on the runtime (or count down time) of the countdown timer 240. Thus, for example, when the autonomous control module 100 is removed from the riding lawn care vehicle 10, the countdown timer 240 may start its run. Initiation of cutting or other operations may then be delayed until after the countdown timer 240 finishes its run and expires. The delay may enable the operator to break any physical contact with the riding lawn care vehicle 10 or otherwise ensure proper preparations have been made for autonomous operation of the riding lawn care vehicle 10.

The learning module 220 (or processing circuitry 210) of some embodiments may employ further functionality in connection with executing the program 222 in some cases. For example, in some embodiments a break release command 242 may be issued (e.g., to the brakes 160) in order to release the parking brake, or other brakes, when the countdown timer 240 expires. Additionally, or alternatively, an audio output 244 and/or deck height adjustment command 246 may be issued to provide notice of the shift to autonomous mode of operation or change deck height to a pre-programmed height defined in the program 222 upon expiry of the countdown timer 240. In some embodiments, the lights 168 may be actuated during autonomous operation and the lights 168 may include headlights, hazard lights, a light bar, or various other light indicators disposed at various locations on the riding lawn care vehicle 10. In still other embodiments, commands may be issued in association with attachment engagement 248 to various accessories or other functional equipment. For example, the attachment engagement 248 commands may include functional controls associated with a bagger, a snow thrower, lifting/lowering a blade, etc.

Accordingly, some example embodiments may provide a riding lawn care vehicle that may include an engine to selectively power the riding lawn care vehicle, a power supply to provide electrical power to the riding lawn care vehicle, and an autonomous control module. The autonomous control module may include a vehicle interface and a shutdown controller. The vehicle interface may define a physical and electrical connection to the riding lawn care vehicle to enable the autonomous control module to alternately be installed at or removed from the riding lawn care vehicle to transition a mode controller of the riding lawn care vehicle between a manual operation mode when the autonomous control module is installed at the riding lawn care vehicle and an autonomous operation mode when the autonomous control module is removed from the riding lawn care vehicle. The shutdown controller may be configured to enable a remote shutdown of the engine of the riding lawn care vehicle when actuated by an operator while the riding lawn care vehicle is in the autonomous operation mode.

In some embodiments, the system may include additional, optional features, and/or the features described above may be modified or augmented. Some examples of modifications, optional features and augmentations are described below. It should be appreciated that the modifications, optional features and augmentations may each be added alone, or they may be added cumulatively in any desirable combination. In this regard, for example, the autonomous control module may further include a wireless transmitter configured to transmit a shutdown command wirelessly to the riding lawn care vehicle responsive to actuation of the shutdown controller. In an example embodiment, the autonomous control module may further include an internal power supply that is charged via the power supply of the riding lawn care vehicle when the autonomous control module is installed at the riding lawn care vehicle. In some cases, the vehicle interface may be inserted between the power supply and a battery receptacle of the riding lawn care vehicle when the autonomous control module is installed at the riding lawn care vehicle. In such an example, the power supply installs directly into the battery receptacle of the riding lawn care vehicle when the autonomous control module is removed from the riding lawn care vehicle. In an example embodiment, the autonomous control module may further include a human machine interface (HMI) enabling a remote control instruction for operation of the riding lawn care vehicle to be provided remotely in the autonomous operation mode. In some cases, the HMI may be used to define an autonomous operation program for the mode controller, and the mode controller may execute the autonomous operation program in the autonomous operation mode. In an example embodiment, the mode controller may be configured to turn on a camera disposed at the riding lawn care vehicle and transmit image data to the HMI during the autonomous operation mode. In some cases, the riding lawn care vehicle may further include a learning module configured to learn one or more autonomous operation programs while the autonomous control module is installed at the riding lawn care vehicle. The learning module may be configured to automatically execute one of the one or more autonomous operation programs responsive to the autonomous control module being removed from the riding lawn care vehicle. In an example embodiment, the one or more autonomous operation programs may include a predefined cutting deck height, and the mode controller may cause an adjustment of a cutting deck of the riding lawn care vehicle to the predefined cutting deck height responsive to executing the one of the one or more autonomous operation programs.

In some cases, the riding lawn care vehicle further comprises a countdown timer that starts responsive to removal of the autonomous mode controller from the riding lawn care vehicle and counts down a predetermined time after starting until expiration. In such examples, the autonomous operation mode may be initiated responsive to the expiration of the countdown timer. In an example embodiment, the riding lawn care vehicle may include an audio output for making an audible warning noise while the countdown timer counts down. In some examples, the audible warning noise may include a numerical countdown to initiation of the autonomous operation mode. In an example embodiment, a parking brake of the riding lawn care vehicle may be released responsive to the expiration of the countdown timer.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe exemplary embodiments in the context of certain exemplary combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. In cases where advantages, benefits, or solutions to problems are described herein, it should be appreciated that such advantages, benefits, and/or solutions may be applicable to some example embodiments, but not necessarily all example embodiments. Thus, any advantages, benefits, or solutions described herein should not be thought of as being critical, required, or essential to all embodiments or to that which is claimed herein. Although specific terms are employed herein, they are used in a generic and descriptive sense only and not for purposes of limitation.

That which is claimed:

1. An autonomous control module for a riding lawn care vehicle, the autonomous control module comprising:
a vehicle interface defining a physical and electrical connection to the riding lawn care vehicle to enable the autonomous control module to alternately be installed at or removed from the riding lawn care vehicle to transition a mode controller of the riding lawn care vehicle between a manual operation mode when the autonomous control module is installed at the riding lawn care vehicle and an autonomous operation mode when the autonomous control module is removed from the riding lawn care vehicle; and
a shutdown controller configured to enable a remote shutdown of the riding lawn care vehicle when actuated by an operator while the riding lawn care vehicle is in the autonomous operation mode.

2. The autonomous control module of claim 1, wherein the autonomous control module further comprises a wireless transmitter configured to transmit a shutdown command wirelessly to the riding lawn care vehicle responsive to actuation of the shutdown controller.

3. The autonomous control module of claim 1, wherein the autonomous control module further comprises an internal power supply that is charged via a power supply of the riding lawn care vehicle when the autonomous control module is installed at the riding lawn care vehicle.

4. The autonomous control module of claim 3, wherein the vehicle interface is inserted between the power supply and a battery receptacle of the riding lawn care vehicle when the autonomous control module is installed at the riding lawn care vehicle, and
wherein the power supply installs directly into the battery receptacle of the riding lawn care vehicle when the autonomous control module is removed from the riding lawn care vehicle.

5. The autonomous control module of claim 1, wherein the autonomous control module further comprises a human machine interface (HMI) enabling a remote control instruction for operation of the riding lawn care vehicle to be provided remotely in the autonomous operation mode.

6. The autonomous control module of claim 5, wherein the HMI is used to define an autonomous operation program for the mode controller, and
wherein the mode controller executes the autonomous operation program in the autonomous operation mode.

7. The autonomous control module of claim 5, wherein the mode controller is configured to turn on a camera disposed at the riding lawn care vehicle and transmit image data to the HMI during the autonomous operation mode.

8. A riding lawn care vehicle comprising:
an engine to selectively power the riding lawn care vehicle;
a power supply to provide electrical power to the riding lawn care vehicle; and
an autonomous control module comprising:
a vehicle interface defining a physical and electrical connection to the riding lawn care vehicle to enable the autonomous control module to alternately be installed at or removed from the riding lawn care vehicle to transition a mode controller of the riding lawn care vehicle between a manual operation mode when the autonomous control module is installed at the riding lawn care vehicle and an autonomous operation mode when the autonomous control module is removed from the riding lawn care vehicle; and
a shutdown controller configured to enable a remote shutdown of the engine of the riding lawn care vehicle when actuated by an operator while the riding lawn care vehicle is in the autonomous operation mode.

9. The riding lawn care vehicle of claim 8, wherein the autonomous control module further comprises a wireless transmitter configured to transmit a shutdown command wirelessly to the riding lawn care vehicle responsive to actuation of the shutdown controller.

10. The riding lawn care vehicle of claim 8, wherein the autonomous control module further comprises an internal power supply that is charged via the power supply of the riding lawn care vehicle when the autonomous control module is installed at the riding lawn care vehicle.

11. The riding lawn care vehicle of claim 10, wherein the vehicle interface is inserted between the power supply and a battery receptacle of the riding lawn care vehicle when the autonomous control module is installed at the riding lawn care vehicle, and
wherein the power supply installs directly into the battery receptacle of the riding lawn care vehicle when the autonomous control module is removed from the riding lawn care vehicle.

12. The riding lawn care vehicle of claim 8, wherein the autonomous control module further comprises a human machine interface (HMI) enabling a remote control instruction for operation of the riding lawn care vehicle to be provided remotely in the autonomous operation mode.

13. The riding lawn care vehicle of claim 12, wherein the HMI is used to define an autonomous operation program for the mode controller, and
wherein the mode controller executes the autonomous operation program in the autonomous operation mode.

14. The riding lawn care vehicle of claim 12, wherein the mode controller is configured to turn on a camera disposed at the riding lawn care vehicle and transmit image data to the HMI during the autonomous operation mode.

15. The riding lawn care vehicle of claim 8, further comprising a learning module,
wherein the learning module is configured to learn one or more autonomous operation programs while the autonomous control module is installed at the riding lawn care vehicle, and
wherein the learning module is configured to automatically execute one of the one or more autonomous operation programs responsive to the autonomous control module being removed from the riding lawn care vehicle.

16. The riding lawn care vehicle of claim 15, wherein the one or more autonomous operation programs includes a predefined cutting deck height, and
wherein the mode controller causes an adjustment of a cutting deck of the riding lawn care vehicle to the predefined cutting deck height responsive to executing the one of the one or more autonomous operation programs.

17. The riding lawn care vehicle of claim 8, further comprising a countdown timer that starts responsive to removal of the autonomous mode controller from the riding lawn care vehicle and counts down a predetermined time after starting until expiration,
wherein the autonomous operation mode is initiated responsive to the expiration of the countdown timer.

18. The riding lawn care vehicle of claim 17, wherein the riding lawn care vehicle makes an audible warning noise when the countdown timer counts down.

19. The riding lawn care vehicle of claim 18, wherein the audible warning noise includes a numerical countdown to initiation of the autonomous operation mode.

20. The riding lawn care vehicle of claim 17, wherein a parking brake of the riding lawn care vehicle is released responsive to the expiration of the countdown timer.
